(19) United States
(12) Patent Application Publication
(10) Pub. No.: US 2012/0112478 A1
(43) Pub. Date: May 10, 2012

(54) ENERGY ABSORBING BEAM WITH CONTROLLED CRUSH CHARACTERISTICS

(76) Inventor: Thomas Vikstrom, Troy, MI (US)

(21) Appl. No.: 13/353,724

(22) Filed: Jan. 19, 2012

Related U.S. Application Data
(63) Continuation of application No. 12/939,499, filed on Nov. 4, 2010, now abandoned.
Application No. 12/939,499 is a continuation of application No. 12/421,200, filed on Apr. 9, 2009, now abandoned.
(60) Provisional application No. 61/043,837, filed on Apr. 10, 2008.

(51) Int. Cl. B60R 19/18; B32B 15/01; B21D 5/12; B32B 1/08

(52) U.S. Cl. 293/102; 428/34.1; 428/587; 72/176

(57) ABSTRACT

An energy absorbing beam structure has controlled crush characteristics. The beam is an elongated structure in which at least a portion of the length of the beam is configured so that a cross section taken transverse to the length of the beam defines a first sidewall, a second sidewall, a first hollow flange projecting from the first sidewall and a second hollow flange projecting from the second sidewall together with a front wall extending between the first and second sidewalls. The beam may be configured to define an open or closed tubular structure and may define one or more central lobes. In an impact condition the beam crushes in a reliable and controlled manner so as to absorb a large amount of kinetic energy. Further disclosed are motor vehicles which include the energy absorbing beams as well as roll forming processes for fabricating the beams.

### CROSS-REFERENCE TO RELATED APPLICATIONS

This application is a continuation of U.S. patent Ser. No. 12/939,499, filed Nov. 4, 2010 which claims priority to U.S. patent application Ser. No. 12/421,200 filed Apr. 9, 2009, which claims priority of U.S. Provisional Patent Application Ser. No. 61/043,837 filed Apr. 10, 2008, entitled “Energy Absorbing Beam with Controlled Crush Characteristics”, which is incorporated herein by reference.

### FIELD OF THE INVENTION

This invention relates, generally, to energy absorbing structures. More specifically the invention relates to energy absorbing beams of the type incorporated into motor vehicles. Most specifically the invention relates to energy absorbing beams having controlled crush characteristics.

### BACKGROUND OF THE INVENTION

Motor vehicles and other articles of construction can incorporate energy absorbing protective structures therein. These structures are frequently configured as beams, and in the context of this disclosure the energy absorbing structures of the present invention will be referred to as “beams”, and it is to be understood that they may be variously configured. In the case of motor vehicles, the beams are incorporated into bumper systems, side intrusion protection systems, and other portions of the body of a motor vehicle, and function to protect users and cargo in the event of a high energy impact, by absorbing and dispersing kinetic energy. Weight is a significant concern in motor vehicles, and hence the strength to weight ratio of energy absorbing beams is significant.

As will be explained hereinbelow, the present invention provides a unique structure of energy absorbing beam. The beams of the present invention are specifically configured so that when they are impacted, they crush in a very controlled and repeatable manner so as to absorb and dissipate energy in an efficient manner. The beams of the present invention are light in weight but capable of absorbing and dissipating very large amounts of energy. These and other advantages of the invention will be apparent from the drawings, discussion and description which follow.

### SUMMARY OF THE INVENTION

Disclosed herein is an energy absorbing structure having controlled crush characteristics. The structure is configured as an elongated beam wherein at least a portion of the length of the beam is configured so that a cross section thereof taken transverse to the length of the beam defines a first sidewall, a second sidewall, a first hollow flange projecting from the first sidewall, a second hollow flange projecting from the second sidewall, and a front wall extending between said first and second sidewalls. The structure may further include a rear wall extending between said first sidewall and said second sidewall wherein at least a portion of the length of the rear wall is spaced from the front wall.

The flanges may, in particular instances, project from their respective sidewalls, and from the rear wall in those instances where the beam structure includes a rear wall, in a direction transverse to the length of the beam. In such instances, the flanges may be separated from their respective sidewalls, and any rear wall, by a channel which extends in a direction along the length of the beam.

In particular instances, the beam is configured to include a first and second sidewall, a front wall and a rear wall which define a single lobe which comprises a central portion of the beam. In other instances, the sidewalls, front wall and rear wall will define a multi-lobe which comprises a central portion of the beam.

In yet other instances, a portion of the length of the front wall may be indented so that the indented portion is closer to a rear wall than is the remainder of the front wall. The beam may be configured to have a cross section which is closed or open, and in yet other instances, at least one of the sidewalls may be configured to define a first and second planar portion which join together in an angular relationship so as to define a break point therebetween which aids in controlling the crush characteristics of the beam.

The beam may be fabricated from steel, and in particular instances it may be fabricated from high strength boron steel. The thickness of the steel may be in the range of 0.5 to 5.0 millimeters.

Further disclosed are methods for forming the beams wherein at least portions of the beams are fabricated from sheets of stock material in a roll forming process. Further disclosed are motor vehicles which include the energy absorbing beams of the present invention.

### BRIEF DESCRIPTION OF THE DRAWINGS

FIG. 1 is a cross-sectional view of a first configuration of energy absorbing beams structured in accord with the principles of the present invention;

FIG. 2 is a perspective drawing of a portion of a beam generally similar to the beam of FIG. 1;

FIG. 3 is a cross-sectional view of another configuration of beam structured in accord with the principles of the present invention;

FIGS. 4A-4D are cross-sectional views of an embodiment of single lobe beam in accord with the present invention at various stages of crushing as would occur in a high-speed impact;

FIGS. 5A-5B are cross-sectional views of a multi-lobe beam of the present invention at various stages of crushing as would occur in a high-speed impact;

FIG. 6A is a graph showing the crush behavior of beams of the present invention and beams of the prior art under low speed crash conditions;

FIG. 6B is a graph showing behavior of a beam of the present invention and a beam of the prior art under medium speed crash conditions; and

FIGS. 7-9 are force/displacement curves comparing the crash behavior of lobed beams of the present invention with corresponding non-lobed beams of the prior art.

### DETAILED DESCRIPTION OF THE INVENTION

The energy absorbing structures of the present invention may be fabricated in a variety of configurations; but in general, they comprise elongated beam members in which at least a portion of the length of the beam has a cross section, taken transverse to the length of the beam, which is tubular, insofar as it at least partially encloses an interior space. As such, the cross section may be completely closed or may be open to some degree. Also, while the cross section is described as “tubular”, it is to be understood that it need not be circular or otherwise curved. The cross-sectional portion defines a first sidewall having a first hollow flange projecting from it transverse to the length of the beam. The cross section further defines a second sidewall having a second hollow flange projecting from it transverse to the length of the beam. A front wall extends between the first and second sidewalls, and a rear wall extends between the first and second sidewalls. At least a portion of the length of the rear wall is spaced from the front wall. Some particular configurations of energy absorbing beam are shown in the accompanying figures.

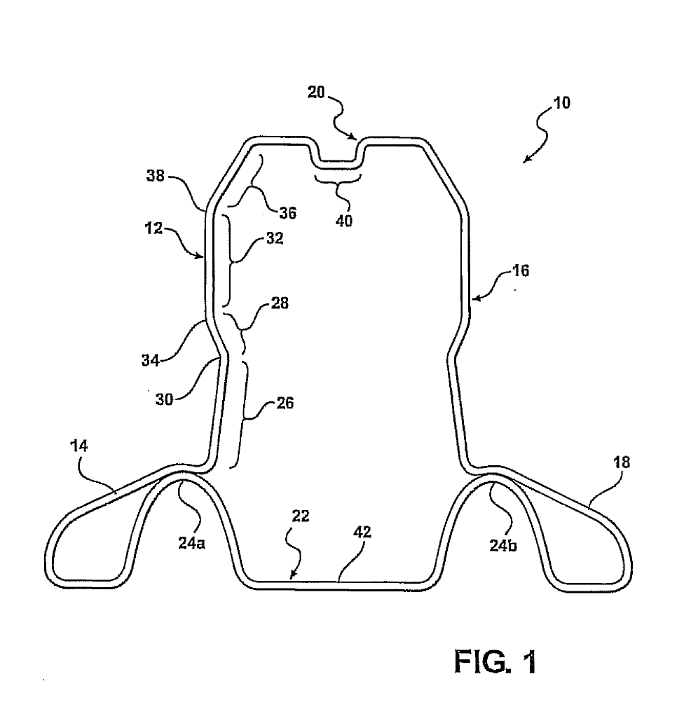

FIG. 1 shows a cross-sectional view of a first configuration of beam 10. The beam includes a first sidewall 12 having a first hollow flange 14 projecting therefrom. The beam further includes a second sidewall 16 having a second hollow flange 18 projecting therefrom. A front wall 20 extends between the first sidewall 12 and the second sidewall 16. Likewise a rear wall 22 extends between the first sidewall 12 and the second sidewall 16. In the FIG. 1 illustration, the hollow flanges 14 and 18 are separated from the rear wall 22 and the sidewalls 12 and 16 by grooves 24a, 24b which extend along the length dimension of the beam 10.

It will also be seen from FIG. 1 that the interior portions of the hollow flanges 14, 18 are separate from the interior portions of the remainder of the beam as bounded by the sidewalls 12, 16, front wall 20 and rear wall 22. However, in other embodiments, the interior volume of one or more of the flanges may be, to some degree, contiguous with the interior volume of the remainder of the beam; and in that regard, the grooves 24a, 24b may not completely close off the interior volume of the flanges 14, 18.

It should be noted that terms such as: “front”, “top”, “bottom”, “rear” and “back” as applied to the walls, are relative and are used for purposes of reference and description herein. These terms are not meant to imply any specific orientation of the beam when in use; and as such, these terms are interchangeable.

As will further be seen, the sidewalls 12 and 16 each include a plurality of generally planar portions which join together in an angular relationship so as to define break points. Specifically, sidewall 12 includes a first planar portion 26 which joins to a second planar portion 28 in an angular relationship defining a first break point 30. Likewise, the second planar portion 28 joins to a third planar portion 32 to define another break point 34. Likewise, the third planar portion 32 joins to a fourth planar portion 36 to define yet another break point 38. The second side wall 16 is similarly configured. It should be noted that while the embodiments of FIGS. 1-3 show a plurality of break points on each of the side walls, other embodiments may include only a single break point; and in some instances, the beam may include no break points. In the FIG. 1 embodiment, the front wall 20 is configured so that a central portion 40 projects inward in the direction of the rear wall 22 so as to define a channel. In other embodiments, the front wall 20 may be configured to define a plurality of channels, or it may not define a channel at all.

In the FIG. 1 embodiment, the sidewalls, front wall, and rear wall cooperate to define a single lobed central portion which, in this instance, bounds a completely closed volume; and in this regard, portions of the rear wall 22 are joined together by a weld 42. In other embodiments, the profile of the cross section may be open.

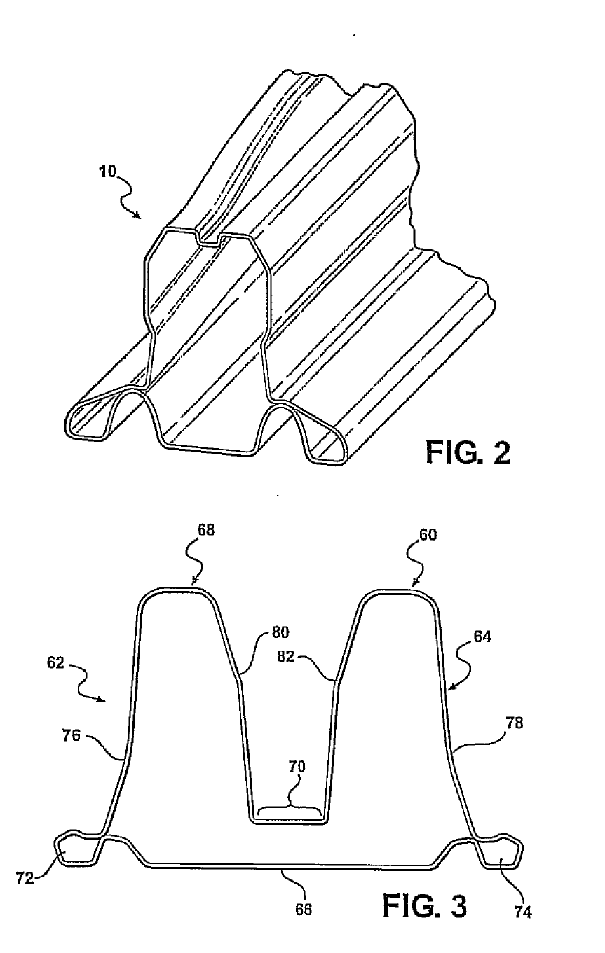

Referring now to FIG. 2, there is shown a perspective drawing of a portion of the beam 10 of FIG. 1. As will be seen, the cross section of the beam may vary along its length, and the beam may include attachment features such as flanges, brackets or the like. Also, the beam may be curved, swept, bent, or otherwise shaped to accommodate particular applications. The beams of the present invention may be fabricated in a variety of processes. However, in some specific instances, the beams are advantageously fabricated, at least in part, by a roll forming process wherein a sheet of stock material is sequentially shaped through a series of rolling stations to produce the final cross-sectional profile. In further processing steps, the thus formed beam stock may be further shaped by sweeping, bending, or the like to produce a finished article. As is known in the art, appropriate heat treating or other metallurgical operations may be carried out to enhance the strength, ductility, or other metallurgical properties of the resultant article.

The beams of the present invention are fabricated from materials having controlled deformation characteristics. These materials will typically be metals, although polymeric materials and composite materials may also be employed. In some instances, the beams will be fabricated from steel stock. In specific instances they will be fabricated from steel stock having a thickness in the range of 0.5 to 5.0 millimeters. In certain instances, the beams will be fabricated from a high strength steel such as an ultra high strength boron steel.

Various other configurations of beam cross section may be readily implemented in accord with the present invention. Referring now to FIG. 3, there is shown a cross-sectional view of another configuration of beam 60 in which the sidewalls, front wall and rear wall cooperate to define a multi-lobe structure; and in this specific instance, a dual lobed structure. This beam includes a first sidewall 62, a second sidewall 64 and a rear wall 66 as previously described. In this embodiment, the front wall 68 has a deeply indented portion 70 which projects toward the rear wall 66 and is closer thereto than is the remainder of the front wall. As shown in this embodiment, the indented portion 70 is spaced from the rear wall 66; however, it is to be understood that in some instances, it may actually be in contact with the rear wall 66, or it may be spaced further therefrom. In yet other embodiments, the front wall may be configured to include several indented portions so as to define a third lobe or further numbers of lobes. Also, it is to be understood that the rear wall 66 need not be planar as illustrated herein, but may also be indented or otherwise configured.

As in the previous embodiments, the beam 60 includes first and second flanges 72, 74 and the sidewalls are configured to include break points 76, 78. In this embodiment, the portions of the front wall which are projecting into the central portion of the cross section are configured so as to define additional break points 80 and 82.

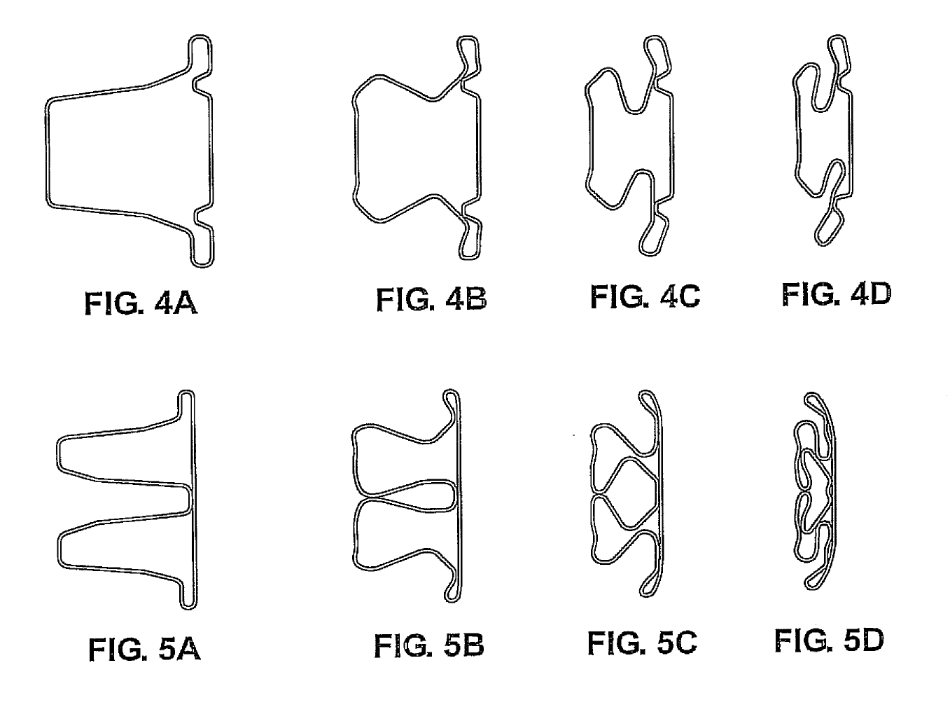

The beam structures of the present invention are uniquely configured and their configuration allows them to crush in a very controlled and repeatable manner when subjected to an impact. The controlled crushing characteristics allow the beams to absorb and dissipate high levels of kinetic energy with regard to their weight. FIGS. 4A-4D show the behavior of a typical single lobe beam of the present invention under high speed impact crush conditions. Likewise, FIGS. 5A-5B depict the behavior of a typical multi-lobe beam of the present invention under similar high speed impact conditions. As will be seen, in both instances the beam collapses in a very controlled manner thereby absorbing large amounts of kinetic energy.

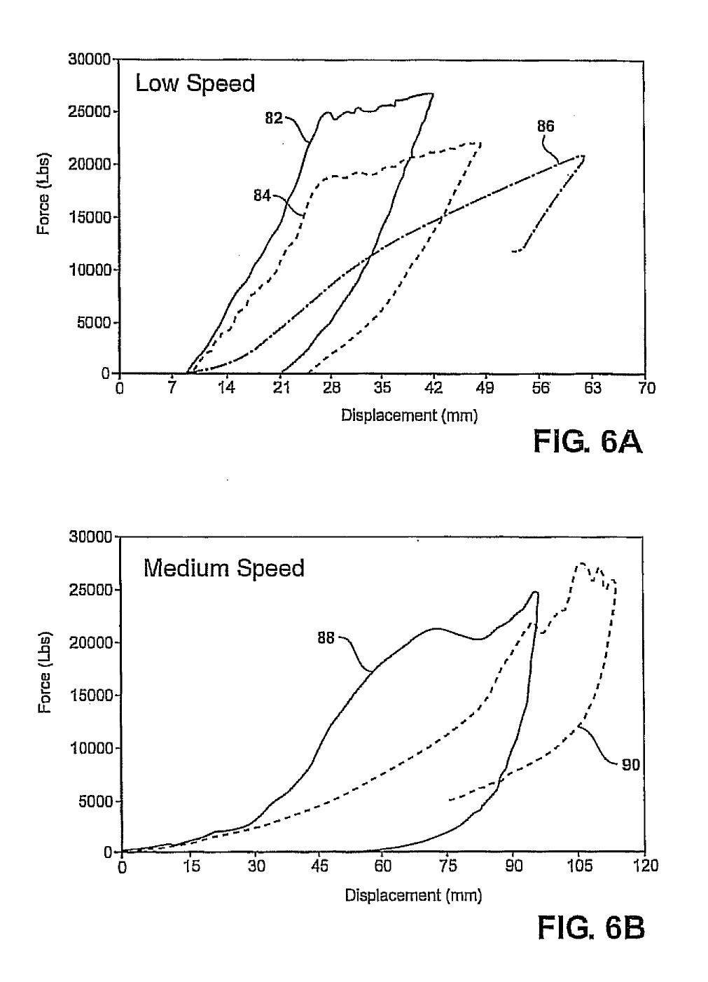

FIG. 6A is a graph depicting crash data of a number of bumper beams in a five mile per hour flat barrier simulated, low speed crash. The graph shows the displacement of a test fixture having a beam mounted thereupon, as a function of applied force. Curve 82 shows test data for a single lobe beam fabricated from 1.3 millimeter thick steel stock. As will be seen, the beam is capable of absorbing relatively large amounts of energy. Curve 84 shows the crash behavior of a single lobe beam of the present invention fabricated from 1.1 millimeter thick steel stock. Again, it will be seen that this beam, although relatively lighter, also absorbs large amounts of energy. Curve 86 shows data for a corresponding bumper beam of the prior art. As will be seen, this beam absorbs far less energy and allows for more displacement than do either of the beams of the present invention. It is also significant that the beam of the prior art as represented by curve 86 has a weight of 13.6 pounds, while the 1.3 millimeter thick beam of the present invention as represented by curve 82 has a weight of 12 pounds and the 1.1 millimeter thick beam of the present invention as represented by curve 84 has a weight of 10 pounds. Therefore, it will be seen that the beams of the present invention not only absorb more energy than does the beam of the prior art, they are also significantly lighter. This factor is very significant in motor vehicle design, since the use of the beams of the present invention not only lightens overall vehicle weight, thereby increasing fuel efficiency, but also increases safety factors.

Referring now to FIG. 6B there is shown the medium speed impact behavior of a beam of the present invention at curve 88, and a beam of the prior art at curve 90. The beam of the present invention has an overall weight of 11.6 pounds and the beam of the prior art has an overall weight of 15.2 pounds. In the experimental series of FIG. 6B, impact occurred at a speed of 10 miles per hour at a 40% offset. As will be seen from FIG. 6B, the beam of the present invention as represented by curve 88 absorbs more energy and allows for less deformation than does the beam of the prior art as represented at curve 90. Furthermore, the beam of the present invention is significantly lighter than the beam of the prior art.

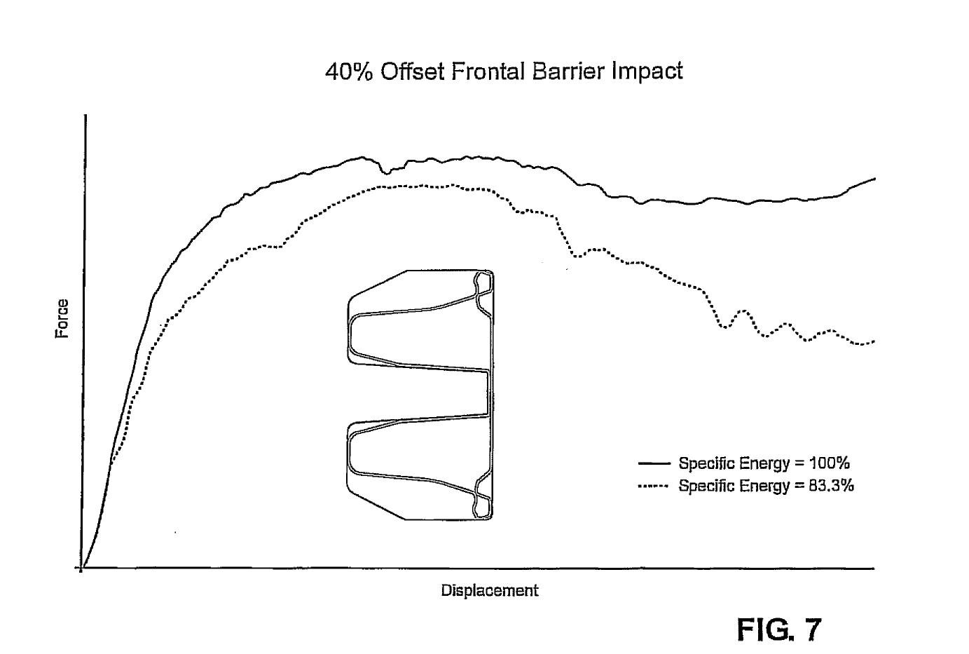

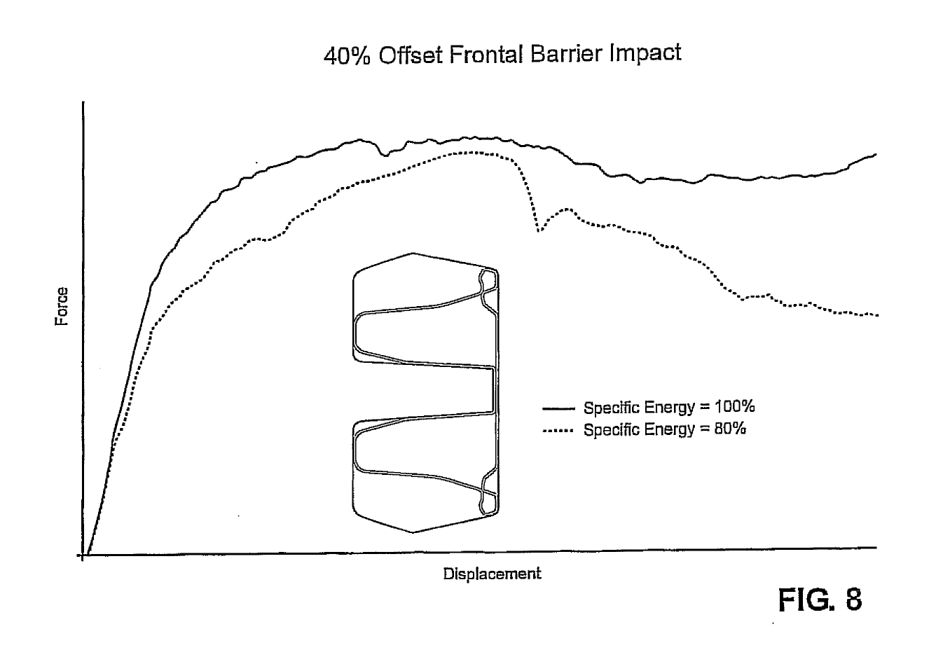

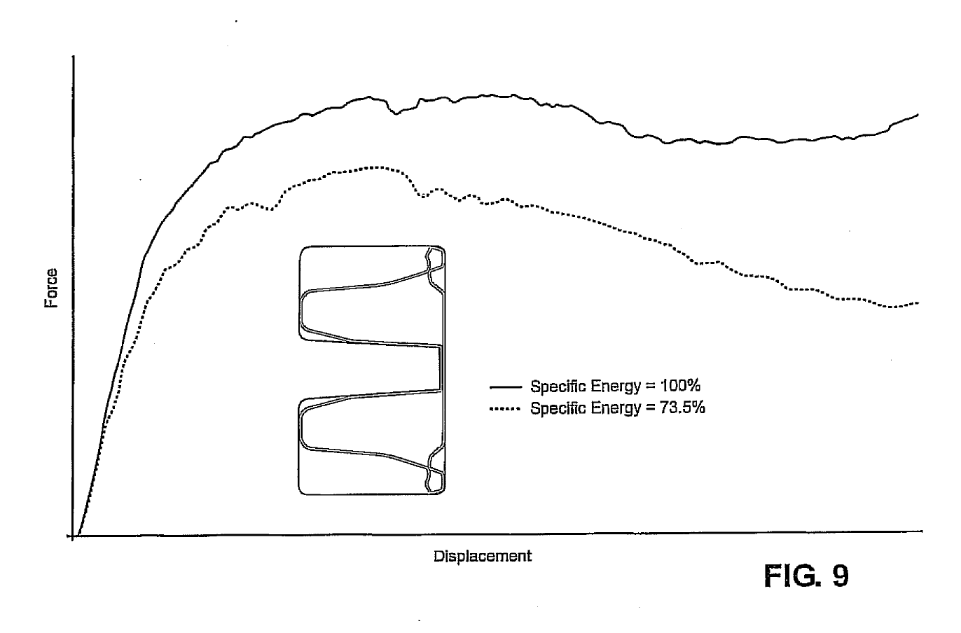

FIGS. 7-9 depict the crush behavior in terms of force/displacement for paired sets of beam structures. In each pair, one member comprises a flanged beam structure in accord with the present invention and the other member comprises a non-flanged beam structure which is otherwise generally similar to the flanged structure of the present invention. The force/displacement curve for the flanged member of each pair is shown by a solid line, and the force/displacement curve for the non-flanged member is shown by the dotted line. The values of the specific energy for the flanged member are normalized to 100% for each pair, and the specific energy for the corresponding non-flanged member is scaled accordingly. In each case, it is clear that the beam structure of the present invention allows for significantly more energy absorption. As will be seen, the beams of the present invention absorb more energy per unit mass than do corresponding prior art beams. As such, the beams of the present invention have higher specific energy absorptions. The beams of the present invention thus may be made to be lighter in weight than prior art beams, without sacrificing any energy absorbing capacity. Alternatively, the beams may be used to provide enhanced strength to vehicles.

The foregoing has described some specific embodiments of energy absorbing beams. It is to be understood that yet other structures may be implemented in accord with the teaching presented herein. The foregoing drawings, discussion and description are not limitations upon the practice of the invention, but are illustrations thereof. It is the following claims, including all equivalents, which define the scope of the invention.

1. An energy absorbing structure having controlled crush characteristics, said structure comprising:
an elongated beam, at least a portion of the length of said beam being configured so that a cross section thereof taken transverse to the length of said beam defines a first sidewall, a second sidewall, a first hollow flange projecting from said first sidewall, a second hollow flange projecting from said second sidewall, and a front wall extending between said first and second sidewalls, said beam being further configured so that the respective interior volumes of said first and second hollow flanges are separate from one another and from the interior portion of the remainder of the beam.

2. The structure of claim 1, further including a rear wall extending between said first sidewall and said second sidewall, at least a portion of the length of said rear wall being spaced from said front wall.

3. The structure of claim 2, wherein said flanges project from their respective sidewalls, and from the rear wall, in a direction transverse to the length of the beam, and are separated from the rear wall by a channel which extends in a direction along the length of the beam.

4. The structure of claim 2, wherein said first and second sidewalls, said front wall, and said rear wall define a single lobe which comprises a central portion of said beam.

5. The structure of claim 2, wherein said first and second sidewalls, said front wall, and said rear wall define a multi-lobe which comprises a central portion of said beam.

6. The structure of claim 5, wherein a portion of the length of said front wall is indented so that said indented portion is closer to said rear wall than is the remainder of said front wall.

7. The structure of claim 1, wherein said cross section is a closed cross section.

8. The structure of claim 1, wherein at least one of said sidewalls comprises a first planar portion and a second planar portion which joins said first planar portion in an angular relationship, so as to define a break point therebetween.

9. The structure of claim 1, wherein said beam is fabricated from steel.

10. The structure of claim 9, wherein said steel is an ultra high strength boron steel.

11. The structure of claim 9, wherein said steel has a thickness in the range of 0.5 to 5.0 millimeters.

12. The structure of claim 1, wherein said structure is fabricated, at least in part, from a roll formed sheet of stock material.

13. The structure of claim 1, wherein said beam is configured as a bumper beam for a motor vehicle.

14. A method for fabricating an energy absorbing structure having controlled crush characteristics, said method comprising the steps of:
providing a sheet of stock material;
shaping said sheet of stock material, at least in part, in a roll forming process so as to define an elongated beam, at least a portion of the length of said beam being configured so that a cross section thereof taken transverse to the length of said beam is configured to define a first sidewall, a second sidewall, a first hollow flange projecting from said first sidewall, a second hollow flange projecting from said second sidewall, and a front wall extending between said first and second sidewalls, said beam being further configured so that the respective interior volumes of said first and second hollow flanges are separate from one another and from the interior portions of the remainder of the beam.

15. The method of claim 14, wherein said sheet of stock material is a sheet of steel.

16. The method of claim 15, wherein said sheet of steel has a thickness in the range of 0.5 to 5.0 millimeters.

17. The method of claim 15, wherein said steel is an ultra high strength boron steel.
